(19) United States
(12) Patent Application Publication
(10) Pub. No.: US 2024/0396820 A1
(43) Pub. Date: Nov. 28, 2024

(54) COMMUNICATION METHOD, ACCESS NETWORK DEVICE, CORE NETWORK ELEMENT, AND TERMINAL DEVICE

(71) Applicant: GUANGDONG OPPO MOBILE TELECOMMUNICATIONS CORP. LTD., Dongguan (CN)

(72) Inventors: Zhe FU, Dongguan (CN); Yali GUO, Dongguan (CN)

(73) Assignee: GUANGDONG OPPO MOBILE TELECOMMUNICATIONS CORP. LTD., Dongguan (CN)

(21) Appl. No.: 18/793,418

(22) Filed: Aug. 2, 2024

Related U.S. Application Data
(63) Continuation of application No. PCT/CN2022/075413, filed on Feb. 7, 2022.

(51) Int. Cl. H04L 43/106; H04L 43/08; H04W 28/02

(52) U.S. Cl. CPC H04L 43/106; H04L 43/08; H04W 28/0278

(57) ABSTRACT

This application provides a communication method, an access network device, a core network element, and a terminal device. According to a first aspect, the method includes: receiving, by an access network device, timestamp information of first data, where the timestamp information is used to indicate a time at which a receiver or sender of the first data is expected to process the first data and/or a time at which the first data is transmitted. Based on the foregoing solution, transmission or resource scheduling can be performed on associated data at the same time or approximately at the same time based on timestamp information, thereby achieving synchronous transmission of the associated data and satisfying a data synchronization requirement.

### CROSS-REFERENCE TO RELATED APPLICATIONS

This application is a continuation of International Application No. PCT/CN2022/075413, filed on Feb. 7, 2022, the disclosure of which is hereby incorporated by reference in its entirety.

### TECHNICAL FIELD

This application relates to the technical field of communications, and more specifically, to a communication method, an access network device, a core network element, and a terminal device.

### BACKGROUND

In some communication scenarios, after receiving data, a data receiver needs to combine the data with other data associated with the data in order to process, for example, play the data. In other words, in these scenarios, a data synchronization requirement needs to be satisfied. Related technologies can achieve data synchronization at an application layer. In some cases, when a data receiver processes specific data, other data associated with the data possibly has not arrived at the application layer, and as a result, the data receiver fails to process the data, thereby failing to satisfy a data synchronization requirement.

### SUMMARY

This application provides a communication method, an access network device, a core network element, and a terminal device, to satisfy a data synchronization requirement.

According to a first aspect, a communication method is provided, including: receiving, by an access network device, timestamp information of first data, where the timestamp information is used to indicate a time at which a receiver or sender of the first data is expected to process the first data and/or a time at which the first data is transmitted.

According to a second aspect, a communication method is provided, including: sending, by a core network element, timestamp information of first data, where the timestamp information is used to indicate a time at which a receiver or sender of the first data is expected to process the first data and/or a time at which the first data is transmitted.

According to a third aspect, a communication method is provided, including: sending, by a terminal device, timestamp information of first data, where the timestamp information is used to indicate a time at which a receiver or sender of the first data is expected to process the first data and/or a time at which the first data is transmitted.

According to a fourth aspect, an access network device is provided, including: a first receiving unit, configured to receive timestamp information of first data, where the timestamp information is used to indicate a time at which a receiver or sender of the first data is expected to process the first data and/or a time at which the first data is transmitted.

According to a fifth aspect, a core network element is provided, including: a first sending unit, configured to send timestamp information of first data, where the timestamp information is used to indicate a time at which a receiver or sender of the first data is expected to process the first data and/or a time at which the first data is transmitted.

According to a sixth aspect, a terminal device is provided, including: a third sending unit, configured to send timestamp information of first data, where the timestamp information is used to indicate a time at which a receiver or sender of the first data is expected to process the first data and/or a time at which the first data is transmitted.

According to a seventh aspect, an access network device is provided, including a processor, a memory, and a communication interface. The memory is configured to store one or more computer programs, and the processor is configured to invoke the computer program in the memory to cause the access network device to perform the method according to the first aspect.

According to an eighth aspect, a core network element is provided, including a processor, a memory, and a communication interface. The memory is configured to store one or more computer programs, and the processor is configured to invoke the computer program in the memory to cause the core network element to perform the method according to the second aspect.

According to a ninth aspect, a terminal device is provided, including a processor, a memory, and a communication interface. The memory is configured to store one or more computer programs, and the processor is configured to invoke the computer program in the memory to cause the terminal device to perform the method according to the third aspect.

According to a tenth aspect, an embodiment of this application provides a communication system, and the system includes one or more of the access network device, the core network element, and the terminal device described above. In another possible embodiment, the system may further include another device interacting with the terminal device or the network device in the solution provided in embodiments of this application.

According to an eleventh aspect, an embodiment of this application provides a computer-readable storage medium. The computer-readable storage medium stores a computer program, and the computer program causes a terminal device to perform some or all of the steps of the method according to the first aspect.

According to a twelfth aspect, an embodiment of this application provides a computer-readable storage medium. The computer-readable storage medium stores a computer program, and the computer program causes a network device to perform some or all of the steps of the method according to the second aspect.

According to a thirteenth aspect, an embodiment of this application provides a computer-readable storage medium. The computer-readable storage medium stores a computer program, and the computer program causes a network device to perform some or all of the steps of the method according to the third aspect.

According to a fourteenth aspect, an embodiment of this application provides a computer program product. The computer program product includes a non-transitory computer-readable storage medium that stores a computer program, and the computer program is operable to cause an access network device to perform some or all of the steps of the method according to the first aspect. In some implementations, the computer program product may be a software installation package.

According to a fifteenth aspect, an embodiment of this application provides a computer program product. The computer program product includes a non-transitory computer-readable storage medium that stores a computer program, and the computer program is operable to cause a core network element to perform some or all of the steps of the method according to the second aspect. In some implementations, the computer program product may be a software installation package.

According to a sixteenth aspect, an embodiment of this application provides a computer program product. The computer program product includes a non-transitory computer-readable storage medium that stores a computer program, and the computer program is operable to cause a terminal device to perform some or all of the steps of the method according to the third aspect. In some implementations, the computer program product may be a software installation package.

According to a seventeenth aspect, an embodiment of this application provides a chip. The chip includes a memory and a processor, and the processor may invoke a computer program from the memory and run the computer program, so as to implement some or all of the steps described in the method according to the first aspect, the second aspect, or the third aspect.

According to an eighteenth aspect, a computer program product is provided, including a program, where the program causes a computer to perform the method according to the first aspect.

According to a nineteenth aspect, a computer program product is provided, including a program, where the program causes a computer to perform the method according to the second aspect.

According to a twentieth aspect, a computer program product is provided, including a program, where the program causes a computer to perform the method according to the third aspect.

According to a twenty-first aspect, a computer program is provided, where the computer program causes a computer to perform the method according to the first aspect.

According to a twenty-second aspect, a computer program is provided, where the computer program causes a computer to perform the method according to the second aspect.

According to a twenty-third aspect, a computer program is provided, where the computer program causes a computer to perform the method according to the third aspect.

### BRIEF DESCRIPTION OF DRAWINGS

FIG. 1 is a schematic diagram of a wireless communication system to which an embodiment of this application is applied.

FIG. 2 is a schematic diagram of a QoS model.

FIG. 3 is a schematic flowchart of a communication method according to an embodiment of this application.

FIG. 4 is a schematic diagram of a structure of a data packet including timestamp information according to an embodiment of this application.

FIG. 5 is a schematic diagram of a structure of a data packet.

FIG. 6 is a schematic flowchart of a communication method according to Embodiment 1 of this application.

FIG. 7 is a schematic flowchart of a communication method according to Embodiment 2 of this application.

FIG. 8 is a schematic flowchart of a communication method according to Embodiment 3 of this application.

FIG. 9 is a schematic flowchart of a communication method according to Embodiment 4 of this application.

FIG. 10 is a schematic flowchart of a communication method according to Embodiment 5 of this application.

FIG. 11 is a schematic flowchart of a communication method according to Embodiment 6 of this application.

FIG. 12 is a schematic diagram of a structure of an access network device according to an embodiment of this application.

FIG. 13 is a schematic diagram of a structure of a core network element according to an embodiment of this application.

FIG. 14 is a schematic diagram of a structure of a terminal device according to an embodiment of this application.

FIG. 15 is a schematic diagram of a structure of a communication apparatus according to an embodiment of this application.

### DESCRIPTION OF EMBODIMENTS

The technical solutions in this application are described below with reference to the accompanying drawings.

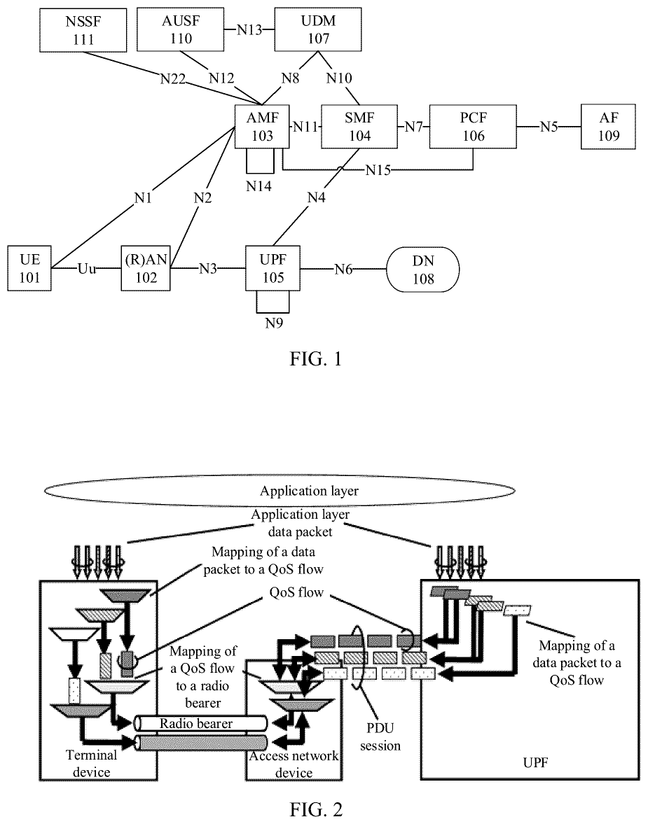

FIG. 1 is a schematic diagram of a wireless communication system to which an embodiment of this application is applicable. It can be understood that embodiments of this application may also be applicable to other wireless communication systems. As shown in FIG. 1, a 5th generation (5G) system or new radio (NR) network architecture released by the 3rd Generation Partnership Project (3GPP) standard organization includes: a terminal device (also referred to as “user equipment (UE)” 101), an access network device 102 (including a radio access network (RAN) or an access network (AN)) that supports 3GPP technologies, a user plane function (UPF) network element 105, an access and mobility management function (AMF) network element 103, a session management function (SMF) network element 104, a policy control function (PCF) network element 106, an application function (AF) network element 109, a data network (DN) 108, a network slice selection function (NSSF) 111, an authentication server function (AUSF) 110, and a unified data management function (UDM) 107.

It should be noted that the network architecture shown in FIG. 1 does not constitute a limitation on the 5G network architecture. In specific implementation, the 5G network architecture may include more or fewer network elements than those shown in the figure, or some network elements may be combined, or the like. In addition, in FIG. 1, R (AN) represents AN or RAN.

The terminal device 101 may be user equipment (UE), a terminal, a handheld terminal, a notebook computer, a subscriber unit, a cellular phone, a smartphone, a wireless data card, a personal digital assistant (PDA) computer, a tablet computer, a wireless modem, a handheld device, a laptop computer, a cordless phone or wireless local loop (WLL) station, a machine type communication (MTC) terminal, a handheld device or computing device having a wireless communication function, a processing device connected to a wireless modem, an unmanned aerial vehicle, an in-vehicle device, a wearable device, a terminal in an internet of things, a virtual reality device, a terminal device in a future communication system (for example, 6G) network, a terminal in a future evolved public land mobile network (PLMN), or the like.

The access network device 102 is an access device for a terminal device to access the network architecture in a wireless manner, and is mainly responsible for radio resource management, quality of service (QOS) management, data compression and encryption, and the like on an air interface side. The access network device 102 may be a base station. The base station may broadly cover the following various names, or may be replaced with the following names, such as a NodeB, an evolved NodeB (eNB), a next generation NodeB (gNB), a relay station, an access point, a transmitting and receiving point (TRP), a transmitting point (TP), a master eNode MeNB, a secondary eNode SeNB, a multi-standard radio (MSR) node, a home base station, a network controller, an access node, a radio node, an access point (AP), a transmission node, a transceiver node, a baseband unit (baseband unit, BBU), a remote radio unit (RRU), an active antenna unit (AAU), a remote radio head (RRH), a central unit (CU), a distributed unit (DU), a positioning node, and the like. The base station may be a macro base station, a micro base station, a relay node, a donor node, or the like, or a combination thereof. Alternatively, the base station may be a communication module, a modem, or a chip disposed in the device or apparatus described above. Alternatively, the base station may be a mobile switching center, a device that functions as a base station in device to device D2D, vehicle-to-everything (V2X), and machine-to-machine (M2M) communications, a network-side device in a 6G network, a device that functions as a base station in a future communication system, or the like. The base station may support networks with a same access technology or different access technologies. A specific technology and a specific device form used by the network device are not limited in embodiments of this application.

The UPF network element 105, the AMF network element 103, the SMF network element 104, and the PCF network element 106 are network elements (referred to as core network elements) of a 3GPP core network. The UPF network element 105 may be referred to as a user plane function network element, which is mainly responsible for transmission of user data. Other network elements may be referred to as control plane function network elements, which are mainly responsible for authentication, authorization, registration management, session management, mobility management, policy control, and the like, to ensure reliable and stable transmission of user data.

The UPF network element 105 (or “UPF” for short) may be used to forward and receive data of a terminal. For example, the UPF network element may receive service data from a data network and transmit the service data to the terminal through an access network device; the UPF network element may further receive user data from the terminal through the access network device and forward the user data to the data network. A transmission resource allocated and scheduled by the UPF network element for the terminal is managed and controlled by the SMF network element. Bearers between the terminal and the UPF network element may include: a user plane connection between the UPF network element and the access network device, and a channel established between the access network device and the terminal. The user plane connection is used to establish a quality of service (QOS) flow for transmitting data between the UPF network element and the access network device.

The AMF network element 103 (or “AMF” for short) may be used to manage access of a terminal to a core network, such as location update, network registration, and access control of a terminal, mobility management of a terminal, attachment and detachment of a terminal, and the like. While providing services for a session of a terminal, the AMF network element may further provide a control plane storage resource for the session, to store a session identifier, an SMF network element identifier associated with the session identifier, and the like.

The SMF network element 104 (or “SMF” for short) may be used to select a user plane network element for a terminal, redirect a user plane network element for a terminal, allocate an internet protocol (IP) address to a terminal, establish a bearer (also referred to as a session) between a terminal and a UPF network element, modify and release a session, and perform QoS control.

The PCF network element 106 (or “PCF” for short) is used to provide policies, such as QoS policies and slice selection policies, to the AMF network element 103 and the SMF network element 104.

The AF network element 109 (or “AF” for short) is used to interact with a 3GPP core network element to support routing of application data, access a network exposure function, interact with a PCF network element for policy control, and so on.

The DN 108 may be an IP multi-media service (IMS) network, the internet, or the like that provide data services for users. The DN 108 may include a plurality of application servers (AS), providing different application services, such as operator services, internet access or third-party services. The AS may implement a function of an AF network element.

The NSSF 111 is used to select a network slice and supports the following functions: selecting a set of network slice instances to serve UE; determining allowed network slice selection assistance information (NSSAI), and when necessary, determining a mapping to subscribed single-network slice selection assistance information (S-NSSAI); determining configured NSSAI, and when necessary, determining a mapping to subscribed S-NSSAI; and determining a set of AMFs that may be used to query UE, or determining a list of candidate AMFs based on a configuration.

The AUSF 110 is used to receive a request from the AMF 103 for authenticating a terminal, and perform authentication processing by requesting a key from the UDM 107 and then forwarding a delivered key to the AMF 103.

The UDM 107 includes functions such as generation and storage of user subscription data and management of authentication data, and supports interaction with an external third-party server.

It should be understood that each network element in FIG. 1 may be a network element in a hardware device, a software function running on dedicated hardware, or a virtualized function instantiated on a platform (for example, a cloud platform). It should be noted that in the network architecture shown in the foregoing figure, network elements included in the entire network architecture are merely described as examples. In embodiments of this application, the network elements included in the entire network architecture are not limited.

For some communication services, data transmission needs to be achieved, and further, other requirements need to be satisfied. For example, during scheduling of a resource for a terminal device, a quality of service (QOS) requirement for data transmission can be satisfied, to satisfy reliability and latency requirements of communication services. Alternatively, for a terminal device, a power consumption requirement of the terminal device can be satisfied, to avoid unnecessary power consumption. In addition, in consideration of access of a large quantity of terminal devices, a network capacity requirement can be considered for resource allocation. For example, URLLC or XR can support services with a minimum latency of 0.5 ms and a reliability of 99.999%.

FIG. 2 is a schematic diagram of a QoS model. For example, the QoS model shown in FIG. 2 may be a QoS model in a 5G system. In a network shown in FIG. 2, QoS control may be implemented based on a QoS flow. After accessing a communication network through an air interface (Uu interface), a terminal device may be controlled by an SMF to map an application layer data packet to a QoS flow, and perform data transmission. The SMF may provide a base station with QoS flow configuration information of each QoS flow. The QoS flow configuration information may include, for example, one or more of the following information: a 5G QoS identifier (5QI), an allocation and retention priority (ARP), a bit rate requirement, and the like. The 5QI may be an index value, and the index value may correspond to, for example, latency and bit error rate requirements. Table 1 shows an example of a latency and a bit error rate corresponding to a 5QI value. The ARP may be a priority of allocating or retaining a resource for a QoS flow by an access network device. For each QoS flow, the access network device may schedule a radio resource based on QoS flow configuration information received from the SMF, to satisfy a QoS requirement of the QoS flow.

TABLE 1

| 5QI value | Latency | Bit error rate |
|---|---|---|
| 66 | 100 ms | 10⁻² |

With the development of technologies, some communication systems (for example, 3GPP 5G systems) are providing increasingly broad and in-depth support for vertical industries. For example, ultra reliable and low latency communication (URLLC) requirements support transmission of services such as factory automation, transport automation (transport industry), and electrical power distribution. Alternatively, extended reality (XR) requirements support transmission of services such as augmented reality (AR), virtual reality (VR), and cloud gaming (CG).

A service model of the VR technology may be: an uplink (UL) service includes pose information, and a downlink (DL) service includes a video stream. A service model of the CG technology may be: a UL service includes control information, and a DL service includes a video stream. A service model of the AR technology may be: a UL service includes pose information and a video stream, and a DL service includes a video stream.

The services described above may be pseudo-periodic. Pseudo-periodicity may mean that service data arrives periodically, but there is jitter in an arrival time of the service data, that is, the service data may not arrive at a definite point, but may arrive at any time within a range. In addition, a service period may be a non-integer period. For example, the period may be 16.67 ms. In addition, different service flows of a same service may arrive at different times (that is, service periods may be different). The time difference may be relatively large.

In one embodiment, for AR, VR or CG services, a period of control information and pose information may be 4 ms, and a packet size requirement is about 100 bytes; and a period of a video stream may be 16.67 ms, and a packet size requirement is about 0.67 Mbps. It can be learned that for an AR UL service, arrival times of pose information and a video stream in one period are different, and packet sizes are also different.

During a data transmission process, application layer data may be exchanged between the terminal device and an application server or a peer terminal device. The application layer data may be obtained through encoding and compression. Application layer data obtained after specific encoding and compression is an application data unit (ADU). For example, the application data unit may be a frame or a coded slice. In an embodiment, an H.264 video codec standard may be used to implement encoding and compression. The H.264 standard may format data by using a network abstract layer (NAL) and provide header information for the application layer data. During an encoding process, a part of a video frame sequence may be compressed into I-frames, a part of a frame sequence may be compressed into P-frames, and a part of a frame sequence may be compressed into B-frames. An I-frame is a key frame, which is intra-frame compressed, and only data of this frame is needed for decoding. A P-frame and a B-frame do not have complete picture data, but have only data of picture differences with adjacent frames. Therefore, when decoding a P frame or a B frame, a picture of an adjacent frame needs to be superimposed on a difference defined by the current frame to generate a displayed picture.

It may be understood that in some services or scenarios, after receiving data, a data receiver needs to combine the data with other data associated with the data before processing (for example, playing or decoding) the data. In other words, in these services or scenarios, a data synchronization requirement needs to be satisfied. For example, in services such as AR, VR, CG, and live videos, there are data streams in a plurality of modes, including voice, video, text, and control information. These data streams usually need to be synchronized with each other. For example, voice, video, captions, and other data need to be displayed to users synchronously. Alternatively, for video services, for a P-frame or B-frame, an adjacent frame needs to be decoded to correctly parse out a video picture.

Related technologies can achieve synchronization between different data at an application layer. For example, an application layer of the data receiver may buffer data and achieve data synchronization based on a time at which the data receiver processes the data. In an implementation, the terminal device may buffer a plurality of types of data such as voice, video, or captions through the application layer. The data to be displayed has been stored in the application layer and when a playing time arrives, the terminal device may synchronously play the plurality of types of data such as voice, video or captions.

In one embodiment, application layer information of the data may include timestamp information, and the timestamp information may be used to indicate a time at which the terminal device is expected to play the data. For example, the timestamp information may include time information for synchronously playing data. The application layer may parse out the time information in the timestamp from the application layer information. After receiving the data, the terminal device may buffer the received data. When a time indicated by the timestamp arrives or approaches, the terminal device may synchronously play associated data. It may be understood that the associated data may include same or similar timestamp information. The data receiver may achieve data synchronization based on the timestamp information.

In some cases, for example, for some services requiring relatively high timeliness, when the data receiver processes the data, other data associated with the data possibly has not arrived at the application layer, and as a result, the data receiver fails to process the data, thereby failing to satisfy a data synchronization requirement. For example, when a playing time of audio data arrives, if the terminal device has not received associated image data, the image data fails to be played simultaneously with the audio data, resulting in a problem of image missing during a video playing process. Alternatively, when a decoding time of a P-frame arrives, if the terminal device has not received an adjacent picture frame, the P-frame fails to be decoded, resulting in garbled characters during playing. Therefore, related technologies may not be able to satisfy a data synchronization requirement, resulting in phenomena such as data interruption, garbled characters, image missing, and voice missing, affecting user experience.

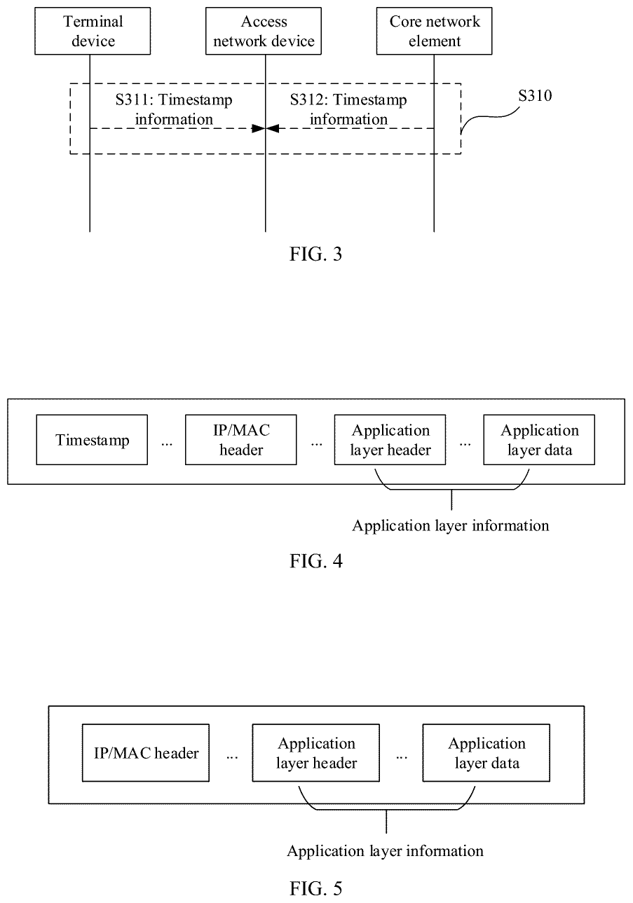

A communication method according to an embodiment of this application is described below with reference to FIG. 3. A method shown in FIG. 3 includes step S310. It should be noted that the method shown in FIG. 3 may be applied to a 5G communication system or any communication system, for example, a 6th generation communication system, or a satellite communication system. For ease of understanding, the following uses the 5G communication system as an example for description. When the foregoing solution is applied to a 6G communication system or another communication system, the network device (core network element and/or access network device) related below may be another network device with a different name but a similar function in the 6G communication system or another communication system.

Step S310: The access network device receives timestamp information of first data.

The first data may include one or more data units. The data unit may be a data packet or a data fragment. For example, the data unit may be frame data, a coded slice, or an ADU in a video. The first data may be data requiring relatively high timeliness, for example, the first data may be media data. In some embodiments, the first data may be referred to as a media data unit.

It should be noted that the first data may be uplink data or downlink data.

The timestamp information may be used to indicate a time at which a receiver or sender of the first data is expected to process the first data and/or a time at which the first data is transmitted.

The receiver may include one or more devices that can receive the first data during a first data transmission process. The receiver may forward the received first data to another receiver. The sender may include one or more devices that send or forward the first data during the first data transmission process. The receiver may include one or more of an access network device, a core network element, an application server, and a terminal device; and the sender may include an access network device, a core network element, an application server, or a terminal device.

That the first data is uplink data is used as an example. The first data may be sent by the terminal device to an application server (or a peer terminal device). The sender of the first data may be the terminal device (local terminal device), an access network device, or a core network device. The receiver of the first data may be one or more of an access network device, a core network device, and an application server (or a peer terminal device).

That the first data is downlink data is used as an example. The first data may be sent by an application server or a peer terminal device to the local terminal device. The sender of the first data may be a peer terminal device, an application server, an access network device, or a core network device. The receiver of the first data may be one or more of an access network device, a core network device, and an application server (or a peer terminal device).

It should be noted that the terminal device may include one or more of an access stratum (AS), a non-access stratum (NAS), and an application layer. It may be understood that one or more of the AS layer, the NAS layer, and the application layer of the terminal device may be receivers.

The timestamp information may be used to indicate a time at which a receiver or sender of the first data is expected to process the first data and/or a time at which the first data is transmitted. The processing of the first data by the receiver or sender may include one or more operations of parsing (or decoding), playing, receiving, or sending the first data, or the like.

In an implementation, the timestamp information may include one or more of the following time information: a time at which the first data is expected to arrive at the receiver, a time at which the first data is expected to be decoded, a time at which the first data is expected to be played, a time at which the receiver is expected to send the first data, a time at which the sender is expected to send the first data, and the time at which the first data is transmitted. It may be understood that the timestamp information may include time information in timestamp information in related technologies, and the timestamp information may also include time information not proposed in related technologies.

The time at which the first data is expected to arrive at the receiver may include one or more of the following: an expected time to arrive at an AS layer of the receiver, an expected time to arrive at a NAS layer of the receiver, and an expected time to arrive at an application layer of the receiver. That the first data is downlink data and the receiver is a terminal device is used as an example. The timestamp information may include one or more of the following time information: one or more of a time at which the first data is expected to arrive at an AS layer of the terminal device, a time at which the first data is expected to arrive at a NAS layer of the terminal device, and a time at which the first data is expected to arrive at an application layer of the terminal device. It may be understood that, in some embodiments, the time information may alternatively be information related to the first data, such as frame information.

The transmission time of the first data may include a sending time or a receiving time of the first data. It may be understood that the transmission time of the first data may be a time at which the first data is actually transmitted.

That the first data is uplink data is used as example. The timestamp information may include one or more of the following time information: an expected time to arrive at a base station, an expected time for decoding, an expected time for playing, an expected time for sending by an access network device, an expected time to arrive at an application server, or the like.

That the first data is downlink data is used as an example. The timestamp information may include one or more of the following time information: a time at which the first data is expected to arrive at the terminal device, an expected time for decoding, an expected time for playing, an expected time for sending by an access network device, or the like.

It may be understood that one piece of data may be associated with one piece of timestamp information, or one piece of timestamp information may be associated with one or more pieces of data.

It may be understood that each piece of data may be associated with a plurality of timestamp information one by one, or a plurality of pieces of data may be associated with one timestamp. In other words, the time information included in the timestamp information may be used not only to indicate the first data, but also to indicate other data. For example, the timestamp information may include period information. The first data is one of a plurality of pieces of data. The plurality of pieces of data are transmitted periodically. In this case, the timestamp information may be used to indicate periodic time information of the plurality of pieces of data.

The access network device may determine a processing policy for the first data based on the timestamp information.

The core network element may determine a processing policy for the first data based on the timestamp information.

The processing policy for the first data includes one or more of the following operations: buffering of the first data; a transmission time of the first data; and resource allocation and/or scheduling of the first data.

In an implementation, the access network device may buffer the first data based on the timestamp information. It may be understood that the buffering means that the first data may not be immediately processed (for example, resource transmission or scheduling). That is, after receiving the first data, the access network device may not transmit or schedule the first data immediately, but may transmit or schedule the first data when a transmission time of the first data arrives.

The transmission time of the first data may be determined based on the timestamp information. For example, when a current time approaches or matches the time information in the timestamp information, the access network device may transmit the first data.

The access network device may determine resource allocation and/or scheduling of the first data based on the timestamp information. For example, when a current time approaches or matches the time information in the timestamp information, the access network device may perform preferential scheduling based on the timestamp information.

In an implementation, the core network device may buffer the first data based on the timestamp information. It may be understood that the buffering means that the first data may not be immediately processed (for example, resource transmission or scheduling) or scheduled. That is, after receiving the first data, the core network device may not transmit or schedule the first data immediately, but may transmit or schedule the first data to the access network device when a transmission time of the first data arrives.

The transmission time of the first data may be determined based on the timestamp information. For example, when a current time approaches or matches the time information in the timestamp information, the core network device may transmit the first data to the access network device, or indicate the access network device to perform transmission.

The core network device may determine resource transmission or allocation of the first data based on the timestamp information. For example, when a current time approaches or matches the time information in the timestamp information, the core network device may perform transmission or preferential transmission based on the timestamp information.

Based on the processing policy, synchronous transmission of the first data and second data can be achieved. The second data may be data associated with the first data. The second data may be data that needs to be synchronized with the first data. For example, the second data may be data that needs to be played synchronously with the first data (for example, caption data, audio data, or pose information). Alternatively, the second data may be data required for decoding the first data. For example, the first data may be a-P frame or a B-frame, and the second data may be a frame adjacent to the first data. For example, the first data is an I-frame, and the second data may be a P-frame or B-frame related to the I-frame. It may be understood that the synchronous transmission may refer to simultaneous transmission or transmission in successive periods of time.

For example, the processing policy for the second data may be determined based on timestamp information of the second data. Based on the processing policy for the first data and the processing policy for the second data, transmission or resource scheduling of the first data and the second data may be performed in at the same time or approximately at the same time, to achieve synchronous transmission of the first data and the second data, thereby satisfying a requirement for synchronization of the first data and the second data.

Therefore, transmission or resource scheduling can be performed on associated data at the same time or approximately at the same time based on timestamp information, thereby achieving synchronous transmission of the associated data and satisfying a data synchronization requirement.

In an implementation, the access network device may further determine the processing policy for the first data based on QoS information and/or associated information of the first data.

It may be understood that the QoS information is considered for determining the processing policy, so that transmission of the first data can satisfy requirements of latency, reliability, and timeliness. For example, a current time is not close to or does not match the timestamp information, but when a transmission latency limit in a QoS requirement is about to be reached, a radio resource is scheduled for sending data by UE.

In at least one embodiment, the QoS information may include, for example, a QoS parameter of a QoS flow corresponding to the first data. The QoS information may be sent by an SMF network element.

The associated information of the first data may be used to indicate information of second data associated with the first data. The associated information may include, for example, QoS association information. It may be understood that, based on the associated information, the access network device may determine a processing policy for the first data and/or the second data, so that the first data can be transmitted synchronously with the second data.

In related technologies, the timestamp information may be included in application layer information of the first data. The access network device cannot directly parse the application layer information. Therefore, in related technologies, the timestamp information is inaccessible to the access network device. Therefore, the access network device cannot directly obtain the timestamp information from the application layer information. This application proposes that an access network device receives timestamp information sent by another device. For example, step S310 may include step S311 and/or step S312. Step S311: The terminal device sends the timestamp information to the access network device. Step S322: The core network element sends the timestamp information to the access network device. It may be understood that the core network element may also send the timestamp information to the terminal device.

The timestamp information may be carried on a user plane, or the timestamp information may be included in a user plane message. The user plane may be an air interface user plane or a core network user plane. In an implementation, the timestamp information may be carried on an air interface user plane, or the timestamp information may be included in an air interface user plane message. Further, the timestamp information may alternatively be carried on a user plane of a core network, or included in a user plane message of a core network (for example, after arriving at the access network device). For example, in a case that the timestamp information is sent by the terminal device, the timestamp information may be carried on an air interface user plane, or the timestamp information may be included in an air interface user plane message. In another implementation, the timestamp information may be carried on a core network user plane, or the timestamp information may be included in a core network user plane message. Further, the timestamp information may alternatively be carried on a user plane of an air interface, or included in a user plane message of an air interface (for example, after arriving at the base station). For example, in a case that the timestamp information is sent by the core network element, the timestamp information may be carried on a core network user plane, or the timestamp information may be included in a core network user plane message.

In an implementation, the timestamp information may be carried in a data packet of the first data. For example, the timestamp information may be carried in a header of the data packet. FIG. 4 is a schematic diagram of a structure of a data packet including timestamp information. A location of the timestamp information in the header of the data packet is not limited in this application.

In another implementation, the timestamp information may be transmitted through an air interface resource or a resource request. For example, the timestamp information may be carried in one or more of the following messages: a media access control control element (MAC CE), uplink control information (UCI), physical layer indication information, scrambling code information, port information, a transmission resource, and a resource request. In at least one embodiment, the transmission resource may include an uplink or downlink transmission resource. For example, the transmission resource may include an uplink shared channel (UL-SCH) or a downlink shared channel (DL-SCH). The resource request may include one or more of the following messages: a buffer status report (BSR), a scheduling request (SR), an uplink scheduling grant (UL grant), and downlink assignment (DL assignment). In at least one embodiment, the physical layer indication information may include downlink control information (DCI). In at least one embodiment, the transmission resource and/or resource request are/is a transmission resource for the first data and/or a resource request for the first data, or a transmission resource corresponding to the first data and/or a resource request for the first data, or a transmission resource and/or a resource request corresponding to other data.

The timestamp information may be carried on a control plane, or the timestamp information may be included in a control plane message. The control plane may be an air interface control plane or a core network control plane. In an implementation, the timestamp information may be carried on an air interface control plane, or the timestamp information may be included in an air interface control plane message. Further, the timestamp information may alternatively be carried on a control plane or user plane of a core network, or included in a control plane or user plane message of a core network (for example, after arriving at the base station). For example, in a case that the timestamp information is sent by the terminal device, the timestamp information may be carried on an air interface control plane, or the timestamp information may be included in an air interface control plane message. In another implementation, the timestamp information may be carried on a core network control plane, or the timestamp information may be included in a core network control plane message. Further, the timestamp information may alternatively be carried on a control plane or user plane of an air interface, or included in a control plane or user plane message of an air interface (for example, after arriving at the base station). For example, in a case that the timestamp information is sent by the core network element, the timestamp information may be carried on a core network control plane, or the timestamp information may be included in a core network control plane message. Specifically, for example, the first data may be uplink data, and the timestamp information may be carried in terminal assistance information (for example, a terminal device dedicated message) and/or a radio resource control (RRC) message. Alternatively, the first data may be downlink data or uplink data, and the timestamp information may be included in a QoS parameter and/or time sensitive communication assistance information (TSCAI).

The core network element may obtain the timestamp information by reading a message sent by the application server or the application layer. For example, a UPF network element may obtain timestamp information based on a data packet of the first data sent by the application server or the application layer. FIG. 5 is a schematic diagram of a structure of a data packet of first data received by a core network element. The data packet shown in FIG. 5 may include an application server or application layer information, where the application server or application layer information may include an application layer header, application layer data, and the like. The UPF network element can decode and read the received application layer information to obtain timestamp information. Alternatively, the application server or the application layer may send timestamp information to the core network element, so that the core network element obtains the timestamp information.

The terminal device may obtain the timestamp information through a message sent by the application layer. For example, the terminal device may read and decode the application layer information in the data packet of the first data, to obtain the timestamp information. Alternatively, the application layer may send the timestamp information to the terminal device. In another implementation, the application layer may first obtain the timestamp information from the application server or the core network element, and then the terminal device obtains the timestamp information through the application server. It should be noted that the application layer may be an application layer of the terminal device.

The terminal device may alternatively obtain the timestamp information of the first data from the core network element or the application server. For example, the core network element or the application server may send the timestamp of the first data to the terminal device, so that the terminal device obtains the timestamp information.

It may be understood that the terminal device and/or the core network element may determine a processing policy for the first data based on the timestamp information. For example, the terminal device and/or the core network element may buffer the first data based on the timestamp information. Alternatively, the core network element may determine resource allocation and/or scheduling of the first data based on a timestamp. Therefore, the first data can be transmitted synchronously throughout an entire transmission process.

That the first data is uplink data is used as example. The terminal device may buffer the first data and/or the second data based on the timestamp information, or the access network device may schedule and allocate a resource for the first data and/or the second data based on the timestamp information, thereby achieving synchronous transmission of the first data and the second data from the terminal device to the access network device.

That the first data is downlink data is used as an example. The core network device may buffer the first data and/or the second data based on the timestamp information, or determine a time for sending the first data and/or the second data to the access network device, thereby achieving synchronous transmission of the first data and the second data from the core network element to the access network device.

Embodiments provided in this application are described below in detail with reference to Embodiment 1 to Embodiment 6. It should be noted that Embodiment 1 to Embodiment 3 are described by using downlink transmission as an example, and Embodiment 4 to Embodiment 6 are described by using uplink transmission as an example. Embodiment 1 to Embodiment 3 may also be applied to uplink transmission. When Embodiment 1 to Embodiment 3 are applied to uplink transmission, for time information included in timestamp information, reference may be made to definitions in Embodiment 4 to Embodiment 6.

### Embodiment 1

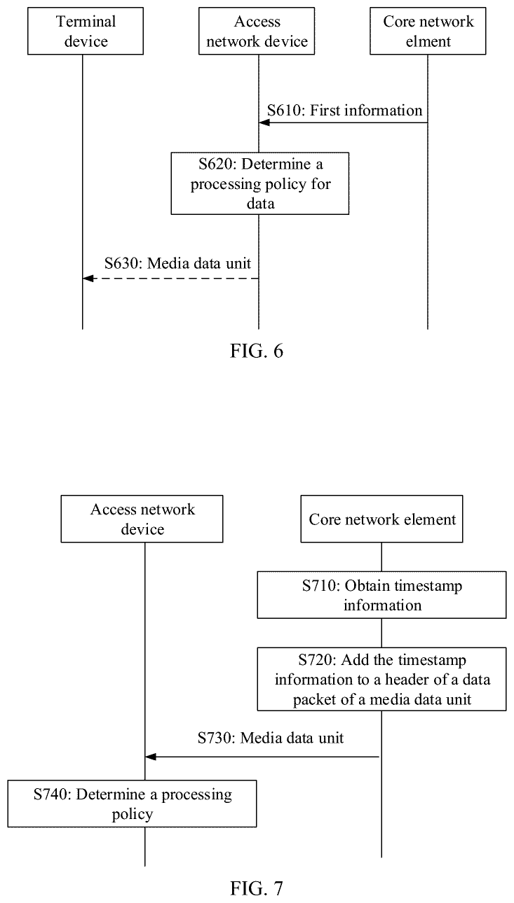

FIG. 6 is a schematic flowchart of a communication method according to Embodiment 1. The method shown in FIG. 6 includes steps S610 and S620. The method shown in FIG. 6 may be implemented by a terminal device, an access network device, and a core network element.

Step S610: The core network element indicates first information to the access network device.

The first information may include one or more of the following information: timestamp information, QoS information, and media data unit association information.

The timestamp information may include one or more of the following time information: a time at which the media data unit is expected to arrive at the terminal device, an expected time for decoding, an expected time for playing, an expected time for sending by an access network device, a time of arriving at an application layer of the terminal device, or the like. The time information may be referred to as frame information.

In an implementation, each media data unit may correspond to one piece of timestamp information. For example, in a case that transmission of the media data unit is aperiodic, the timestamp information may include a time for each media data unit. In another implementation, a plurality of media data units may correspond to one piece of timestamp information. For example, one piece of timestamp information may include a time and a period. In this case, time information of the periodically transmitted media data unit may be calculated based on the time and the period.

It should be noted that a core network element that transmits the timestamp information may be a UPF or an SMF.

The QoS information may include a QoS parameter of a QoS flow. A core network element that transmits the QoS information may be an SMF.

The media data unit association information may include QoS association information. A core network element that transmits the media data unit association information may be an SMF.

Step S620: The access network device determines a processing policy for a media data unit based on the first information. Synchronous transmission of associated media data units may be achieved based on the processing policy.

In an implementation, the processing policy may include one or more of the following operations:
(1) that the access network device buffers the media data unit based on the timestamp information;
(2) that based on the timestamp information, the access network device allocates a resource, or sends the media data unit to the terminal device;
(3) that the access network device sends the media data unit when a current time approaches/matches the timestamp information;
(4) that based on the timestamp information, the access network device preferentially schedules the media data unit with a current time approaching/matching the timestamp information; and
(5) that the base station processes a downlink media data unit based on a QoS requirement and the timestamp information.

The method shown in FIG. 6 may further include step S630. Step S630: The access network device transmits the media data unit to the terminal device based on the processing policy.

It may be understood that, based on Embodiment 1, synchronous transmission of data can be achieved during a downlink data transmission process.

### Embodiment 2

FIG. 7 is a schematic flowchart of a communication method according to Embodiment 2. The method shown in FIG. 7 includes steps S710 to S740. The method shown in FIG. 7 may be implemented by an access network device and a core network element (for example, a UPF).

Step S710: The core network element obtains timestamp information of a media data unit.

The core network element may obtain the timestamp information of the media data unit based on application layer information of the received media data unit (for example, a downlink media data unit). For example, the core network element may decode the media data unit to read the application layer information, so as to obtain the timestamp information.

The timestamp information may include a time at which the media data unit is expected to arrive at a terminal device, an expected time for decoding, an expected time for playing, an expected time for sending by the access network device, or the like.

Step S720: The core network element adds the timestamp information to a header of a data packet of the media data unit.

It should be noted that a location of the timestamp information in the header of the data packet is not limited in this application.

Step S730: The core network element sends the media data unit to the access network device.

The media data unit includes the timestamp information added to the header of the data packet. In other words, the core network element may send the media data unit including the timestamp information to the access network device.

Step S740: The access network device reads the timestamp information in the header of the data packet, and determines a processing policy for the media data unit based on the timestamp information.

The processing policy may include one or more of the following operations:
(1) that the access network device may buffer the media data unit based on the timestamp information;
(2) that based on the timestamp information, the access network device may preferentially schedule a media data unit with a current time approaching/matching the timestamp information;
(3) that based on the timestamp information, the access network device may send the media data unit when a current time approaches/matches the timestamp information; and
(4) that the access network device may process downlink data based on a QoS requirement and the timestamp information.

In an implementation, the access network device may buffer the media data unit based on the timestamp information. A current time is not close to or does not match the timestamp information, but when a transmission latency limit in a QoS requirement is about to be reached, the media data unit is sent.

It may be understood that, based on Embodiment 2, the timestamp information may be obtained through a user plane during downlink data transmission, thereby achieving a method for synchronous data transmission.

### Embodiment 3

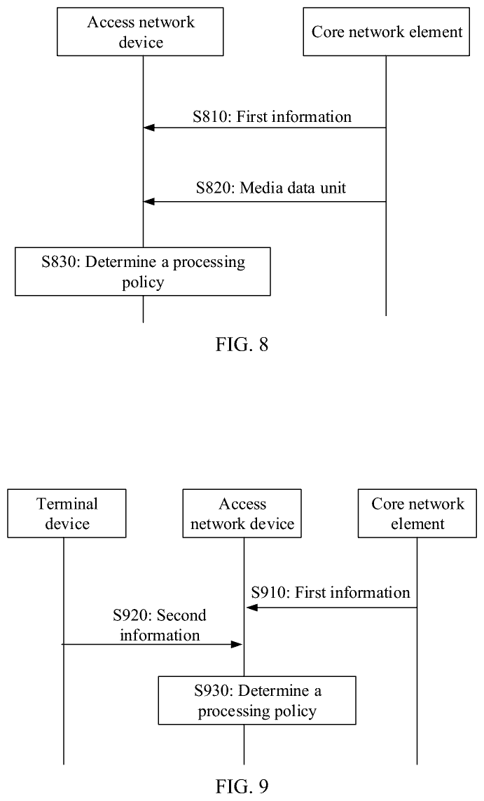

FIG. 8 is a schematic flowchart of a communication method according to Embodiment 3. The method shown in FIG. 8 includes steps S810 to S840. The method shown in FIG. 8 may be implemented by an access network device and a core network element.

Step S810: The core network element sends first information to the access network device. For example, the first information may include timestamp information of a media data unit. The core network element may be an SMF.

The core network element may send the first information of the media data unit to the access network device through a control plane.

The first information may be separately sent to the access network device. The first information may alternatively be sent together with other information to the access network device. For example, the first information may be sent together with QoS information to the access network device.

In an implementation, each media data unit may correspond to one piece of timestamp information. For example, in a case that transmission of the media data unit is aperiodic, the timestamp information may include a time for each media data unit. In another implementation, a plurality of media data units may correspond to one piece of timestamp information. For example, one piece of timestamp information may include a time and a period. In this case, time information of the periodically transmitted media data unit may be calculated based on the time and the period.

The timestamp information may include a time at which the media data unit is expected to arrive at a terminal device, an expected time for decoding, an expected time for playing, an expected time for sending by a base station, or the like.

The core network element may obtain the first information through an application server.

Step S820: The core network element sends a media data unit to the access network device. The core network element may be a UPF.

Step S830: The access network device determines a processing policy for the media data unit based on the first information. The processing policy may include one or more of the following operations:
(1) the access network device may buffer the media data unit based on the timestamp information;
(2) the access network device may send the media data unit when a current time approaches/matches the timestamp information;
(3) based on the timestamp information, the access network device may preferentially process a media data unit with a current time approaching/matching the timestamp information; and
(4) the access network device may process the media data unit based on a QoS requirement and the timestamp information.

In an implementation, the access network device may buffer the media data unit based on the timestamp information. A current time is not close to or does not match the timestamp information, but when a transmission latency limit in a QoS requirement is about to be reached, the media data unit is sent.

It may be understood that, based on Embodiment 3, the timestamp information may be obtained through a control plane during downlink data transmission, thereby achieving a method for synchronous data transmission.

### Embodiment 4

FIG. 9 is a schematic flowchart of a communication method according to Embodiment 4. The method shown in FIG. 9 includes steps S910 to S930. The method shown in FIG. 9 may be implemented by a terminal device, an access network device, and a core network element.

Step S910: The core network element sends first information to the access network device.

In some embodiments, the first information may also be referred to as QoS information.

The first information may include at least one of the following information: QoS related information and media data unit association information. The QoS related information may include a QoS parameter of a QoS flow. The media data unit association information may include a quantity related to associated QoS flows.

It should be noted that a core network element that sends the first information may be an SMF.

Step S920: The terminal device sends second information to the access network device.

In some embodiments, the second information may also be referred to as synchronization information.

The second information may include timestamp information. The timestamp information may include one or more of the following time information: a time at which a media data unit is expected to arrive at the access network device, an expected time for decoding, an expected time for playing, an expected time for sending by the access network device, an expected time to arrive at an application server, or the like. The time information may also be referred to as frame information.

In an implementation, each media data unit may correspond to one piece of timestamp information. For example, in a case that transmission of the media data unit is aperiodic, the timestamp information may include a time for each media data unit. In another implementation, a plurality of media data units may correspond to one piece of timestamp information. For example, one piece of timestamp information may include a time and a period. In this case, time information of the periodically transmitted media data unit may be calculated based on the time and the period.

In at least one embodiment, the terminal device may buffer the media data unit based on the timestamp information. For example, the terminal device may buffer a media data unit that does not match a time indicated by the timestamp information.

Step S930: The access network device determines a processing policy for the media data unit based on the first information and second information, to achieve synchronous transmission.

The processing policy may include one or more of the following operations:
(1) that the access network device may buffer the media data unit based on the timestamp information;
(2) that the access network device may allocate a resource based on the timestamp information;
(3) that the access network device may receive the media data unit when a current time approaches/matches the timestamp information;
(4) that based on the timestamp information, the access network device may preferentially schedule data with a current time approaching or matching the timestamp information; and
(5) that the access network device may process the media data unit based on a QoS requirement and the timestamp information.

It may be understood that, based on Embodiment 4, synchronous transmission of data can be achieved during an uplink data transmission process.

### Embodiment 5

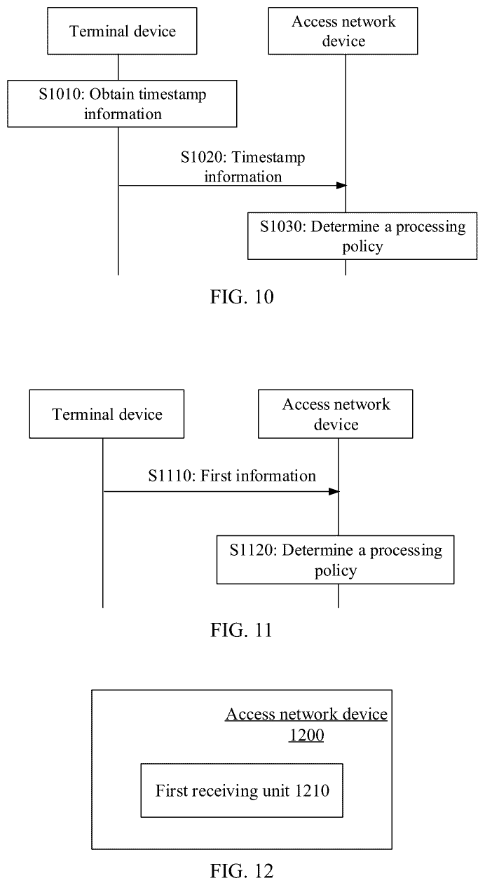

FIG. 10 is a schematic flowchart of a communication method according to Embodiment 5. The method shown in FIG. 10 includes steps S1010 to S1030. The method shown in FIG. 10 may be implemented by a terminal device, an access network device, and a core network element.

Step S1010: The terminal device obtains timestamp information.

The terminal device may read application layer information of a data packet of a media data unit to obtain timestamp information of the media data unit.

The timestamp information may include one or more of the following time information: a time at which the media data unit is expected to arrive at the access network device, an expected time for decoding, an expected time for playing, an expected time for receiving by a base station, an expected time to arrive at an application server, or the like.

The media data unit may include one or more data packets. The media data unit may be, for example, a frame or a coded slice in a video.

Step S1020: The terminal device sends the timestamp information to a network device.

The timestamp information may be carried on a user plane or sent through user plane information. For example, when the terminal device sends a resource request to the access network device, the timestamp information may be carried. In an implementation, the terminal device may write the timestamp information and request a resource through one or more of a BSR, an SR, and a UL grant.

Step S1030: The access network device determines a processing policy for the media data unit.

The processing policy may include one or more of the following operations:
(1) that the access network device may buffer the media data unit based on the timestamp information, and/or deliver the media data unit to a higher layer based on the timestamp information;
(2) that the access network device may schedule and allocate a resource based on the timestamp information;
(3) that the access network device may allocate a resource for the media data unit, perform scheduling, or receive the media data unit when a current time approaches/matches the timestamp information;
(4) that the access network device may schedule a radio resource for the media data unit when a current time approaches/matches the timestamp information, where the radio resource may be used by the terminal device to send data;
(5) that based on the timestamp information, the access network device may preferentially schedule a media data unit with a current time approaching/matching the timestamp information; and
(6) that the access network device may process the media data unit based on a QoS requirement and the timestamp information.

In an implementation, a current time is not close to or does not match the timestamp information, but when a transmission latency limit in a QoS requirement is about to be reached, the access network device may schedule a radio resource so that the terminal device can send data.

It may be understood that, based on Embodiment 5, the timestamp information may be obtained through a user plane during an uplink data transmission process, thereby achieving synchronous data transmission.

### Embodiment 6

FIG. 11 is a schematic flowchart of a communication method according to Embodiment 6. The method shown in FIG. 11 includes Step S1110 and S1120. The method shown in FIG. 11 may be implemented by a terminal device, an access network device, and a core network element.

Step S1110: The terminal device sends first information to the access network device. The first information is used to indicate timestamp information of a media data unit. The first information includes the timestamp information.

The first information may be carried on a control plane, or the first information may be transmitted through control plane information.

The terminal device may read application layer information of the media data unit to obtain the timestamp information. Alternatively, the terminal device may obtain the timestamp information through the core network element.

The first information may be, for example, terminal device assistance information. Alternatively, the first information may be carried in an RRC message.

In an implementation, each media data unit may correspond to one piece of timestamp information. For example, in a case that transmission of the media data unit is aperiodic, the timestamp information may include a time for each media data unit. In another implementation, a plurality of media data units may correspond to one piece of timestamp information. For example, one piece of timestamp information may include a time and a period. In this case, time information of the periodically transmitted media data unit may be calculated based on the time and the period.

The timestamp information may include one or more of the following time information: a time at which the media data unit is expected to arrive at the terminal device, an expected time for decoding, an expected time for playing, an expected time for sending by the access network device, or the like.

Step S1120: The access network device determines a processing policy for the media data unit based on the first information.

The processing policy may include one or more of the following operations:
(1) that the access network device may buffer the media data unit based on the timestamp information; and/or that the access network device may deliver the media data unit to a higher layer based on the timestamp information;
(2) that the access network device may schedule and allocate a resource based on the timestamp information;
(3) that the access network device may allocate or schedule a resource or receive the media data unit when a current time approaches/matches the timestamp information;
(4) that the access network device may schedule a radio resource for the media data unit when a current time approaches/matches the timestamp information, so that the terminal device sends the media data unit;
(5) that based on the timestamp information, the access network device may preferentially schedule data with a current time approaching/matching the timestamp information; and
(6) that the access network device may process the media data unit based on a QoS requirement and the timestamp information.

In an implementation, a current time is not close to or does not match the timestamp information, but when a transmission latency limit in a QoS requirement is about to be reached, a radio resource is scheduled so that the terminal device can send data.

It may be understood that, based on Embodiment 6, the timestamp information may be obtained through a control plane during an uplink data transmission process, thereby achieving synchronous data transmission.

It should be noted that, in some embodiments, the timestamp information may also be referred to as a timestamp.

The method embodiments of this application are described above in detail with reference to FIG. 3 to FIG. 11. The following describes, in detail, apparatus embodiments of this application with reference to FIG. 12 to FIG. 15. It should be understood that the description of the method embodiments corresponds to the description of the apparatus embodiments, and therefore, for parts that are not described in detail, reference may be made to the foregoing method embodiments.

FIG. 12 is a schematic diagram of a structure of an access network device 1200 according to an embodiment of this application. The access network device 1200 may include a first receiving unit 1210.

The first receiving unit 1210 is configured to receive timestamp information of first data, where the timestamp information is used to indicate a time at which a receiver or sender of the first data is expected to process the first data and/or a time at which the first data is transmitted.

In at least one embodiment, the timestamp information is used to determine a processing policy for processing the first data by the access network device.

In at least one embodiment, the access network device 1200 further includes a second receiving unit, configured to receive quality of service QoS information of the first data and/or associated information of the first data, where the associated information is used to indicate information of second data associated with the first data. The QoS information and/or the associated information and the timestamp information are used together to determine a processing policy for processing the first data by the access network device.

In at least one embodiment, the processing policy for the first data includes one or more of the following operations: buffering of the first data; a transmission time of the first data; and resource allocation and/or scheduling of the first data.

In at least one embodiment, the receiver includes one or more of the access network device, a core network element, an application server, and a terminal device; and the sender includes the access network device, a core network element, an application server, or a terminal device.

In at least one embodiment, the terminal device includes one or more of an access stratum AS, a non-access stratum NAS, and an application layer.

In at least one embodiment, the timestamp information includes one or more of the following information: a time at which the first data is expected to arrive at the receiver, a time at which the first data is expected to be decoded, a time at which the first data is expected to be played, a time at which the receiver is expected to send the first data, a time at which the sender is expected to send the first data, and the time at which the first data is transmitted.

In at least one embodiment, the time at which the first data is expected to arrive at the receiver includes one or more of the following: a time at which the first data is expected to arrive at an AS layer of the receiver; a time at which the first data is expected to arrive at a NAS layer of the receiver; and a time at which the first data is expected to arrive at an application layer of the receiver.

In at least one embodiment, the timestamp information is carried on a user plane, or the timestamp information is included in a user plane message.

In at least one embodiment, the timestamp information is carried in a data packet of the first data.

In at least one embodiment, the timestamp information is included in a header of the data packet.

In at least one embodiment, the timestamp information is carried in one or more of the following messages: a medium access control control element MAC CE, uplink control information UCI, physical layer indication information, scrambling code information, port information, a transmission resource, and a resource request.

In at least one embodiment, the transmission resource or the resource request includes one or more of the following messages: a buffer status report BSR, a scheduling request SR, an uplink shared channel UL-SCH, a downlink shared channel DL-SCH, an uplink scheduling grant UL grant, and downlink assignment DL assignment.

In at least one embodiment, the timestamp information is carried on a control plane, or the timestamp information is included in a control plane message.

In at least one embodiment, the timestamp information is carried in terminal assistance information and/or a radio resource control RRC message.

In at least one embodiment, the timestamp information is included in a QoS parameter and/or time sensitive communication assistance information TSCAI.

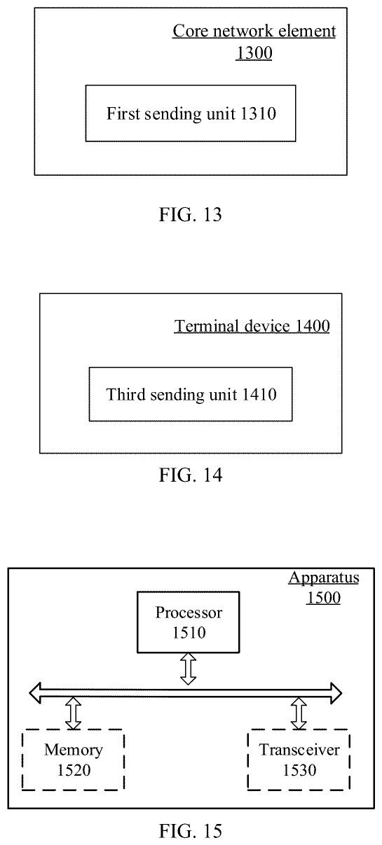

FIG. 13 is a schematic diagram of a structure of a core network element 1300 according to an embodiment of this application. The core network element 1300 may include a first sending unit 1310.

The first sending unit 1310 is configured to send timestamp information of first data, where the timestamp information is used to indicate a time at which a receiver or sender of the first data is expected to process the first data and/or a time at which the first data is transmitted.

In at least one embodiment, the timestamp information is used to determine a processing policy for processing the first data by the access network element.

In at least one embodiment, the core network element 1300 further includes a second sending unit, configured to send quality of service QoS information of the first data and/or associated information of the first data to the access network device, where the associated information is used to indicate information of second data associated with the first data.

In at least one embodiment, the core network element is an SMF network element.

In at least one embodiment, the QoS information and/or the associated information and the timestamp information are used together to determine a processing policy for processing the first data by the access network device.

In at least one embodiment, the timestamp information is used to determine a processing policy for processing the first data by the core network element.

In at least one embodiment, the processing policy for the first data includes one or more of the following operations: buffering of the first data; a transmission time of the first data; and resource allocation and/or scheduling of the first data.

In at least one embodiment, the receiver includes one or more of the access network device, a core network element, an application server, and a terminal device; and the sender includes the access network device, a core network element, an application server, or a terminal device.

In at least one embodiment, the terminal device includes one or more of an access stratum AS, a non-access stratum NAS, and an application layer.

In at least one embodiment, the timestamp information includes one or more of the following information: a time at which the first data is expected to arrive at the receiver, a time at which the first data is expected to be decoded, a time at which the first data is expected to be played, a time at which the receiver is expected to send the first data, a time at which the sender is expected to send the first data, and the time at which the first data is transmitted.

In at least one embodiment, the time at which the first data is expected to arrive at the receiver includes one or more of the following: a time at which the first data is expected to arrive at an AS layer of the receiver; a time at which the first data is expected to arrive at a NAS layer of the receiver; and a time at which the first data is expected to arrive at an application layer of the receiver.

In at least one embodiment, the timestamp information is carried on a user plane, or the timestamp information is included in a user plane message.

In at least one embodiment, the timestamp information is carried in a data packet of the first data.

In at least one embodiment, the timestamp information is included in a header of the data packet.

In at least one embodiment, the timestamp information is carried in one or more of the following messages: a medium access control control element MAC CE, uplink control information UCI, physical layer indication information, scrambling code information, port information, a transmission resource, and a resource request.

In at least one embodiment, the transmission resource or the resource request includes one or more of the following messages: a buffer status report BSR, a scheduling request SR, an uplink shared channel UL-SCH, a downlink shared channel DL-SCH, an uplink scheduling grant UL grant, and downlink assignment DL assignment.

In at least one embodiment, the timestamp information is carried on a control plane, or the timestamp information is included in a control plane message.

In at least one embodiment, the timestamp information is carried in terminal assistance information and/or a radio resource control RRC message.

In at least one embodiment, the timestamp information is included in a QoS parameter and/or time sensitive communication assistance information TSCAI.

In at least one embodiment, the core network element 1300 further includes a first obtaining unit, configured to obtain the timestamp information based on application layer information of the first data.

FIG. 14 is a schematic diagram of a structure of a terminal device 1400 according to an embodiment of this application. The terminal device 1400 may include a third sending unit 1410.

The third sending unit 1410 is configured to send timestamp information of first data, where the timestamp information is used to indicate a time at which a receiver or sender of the first data is expected to process the first data and/or a time at which the first data is transmitted.

In at least one embodiment, the timestamp information is used to determine a processing policy for processing the first data by the access network device.

In at least one embodiment, the timestamp information is used to determine a processing policy for processing the first data by the terminal device.

In at least one embodiment, the processing policy for the first data includes one or more of the following operations: buffering of the first data; a transmission time of the first data; and resource allocation or scheduling of the first data.

In at least one embodiment, the receiver includes one or more of the access network device, a core network element, an application server, and a terminal device; and the sender includes the access network device, a core network element, an application server, or a terminal device.

In at least one embodiment, the terminal device includes one or more of an access stratum AS, a non-access stratum NAS, or an application layer.

In at least one embodiment, the timestamp information includes one or more of the following information: a time at which the first data is expected to arrive at the receiver, a time at which the first data is expected to be decoded, a time at which the first data is expected to be played, a time at which the receiver is expected to send the first data, a time at which the sender is expected to send the first data, and the time at which the first data is transmitted.

In at least one embodiment, the time at which the first data is expected to arrive at the receiver includes one or more of the following: a time at which the first data is expected to arrive at an AS layer of the receiver; a time at which the first data is expected to arrive at a NAS layer of the receiver; and a time at which the first data is expected to arrive at an application layer of the receiver.

In at least one embodiment, the timestamp information is carried on a user plane, or the timestamp information is included in a user plane message.

In at least one embodiment, the timestamp information is carried in a data packet of the first data.

In at least one embodiment, the timestamp information is included in a header of the data packet.

In at least one embodiment, the timestamp information is carried in one or more of the following messages: a medium access control control element MAC CE, uplink control information UCI, physical layer indication information, scrambling code information, port information, a transmission resource, and a resource request.

In at least one embodiment, the transmission resource or the resource request includes one or more of the following messages: a buffer status report BSR, a scheduling request SR, an uplink shared channel UL-SCH, a downlink shared channel DL-SCH, an uplink scheduling grant UL grant, and downlink assignment DL assignment.

In at least one embodiment, the timestamp information is carried on a control plane, or is included in a control plane message.

In at least one embodiment, the timestamp information is carried in terminal assistance information and/or an RRC message.

In at least one embodiment, the timestamp information is included in a quality of service QoS parameter and/or time sensitive communication assistance information TSCAI.

In at least one embodiment, the terminal device 1400 further includes a second obtaining unit, configured to obtain the timestamp information based on application layer information of the first data.

In at least one embodiment, the terminal device 1400 further includes a third receiving unit, configured to receive the timestamp information sent by a core network element or an application server.

FIG. 15 is a schematic diagram of a structure of a communication apparatus according to an embodiment of this application. The dashed lines in FIG. 15 indicate that the unit or module is optional. The apparatus 1500 may be configured to implement the methods described in the foregoing method embodiments. The apparatus 1500 may be a chip, a terminal device, or a network device.

The apparatus 1500 may include one or more processors 1510. The processor 1510 may allow the apparatus 1500 to implement the methods described in the foregoing method embodiments. The processor 1510 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 1500 may further include one or more memories 1520. The memory 1520 stores a program that may be executed by the processor 1510, so that the processor 1510 performs the method described in the foregoing method embodiments. The memory 1520 may be independent of the processor 1510 or may be integrated into the processor 1510.

The apparatus 1500 may further include a transceiver 1530. The processor 1510 may communicate with another device or chip through the transceiver 1530. For example, the processor 1510 may transmit data to and receive data from another device or chip by using the transceiver 1530.

An embodiment of this application further provides a computer-readable storage medium for storing a program. The computer-readable storage medium may be applied to the terminal or the network device provided in embodiments of this application, and the program causes a computer to perform the methods performed by the terminal or the network device in various embodiments of this application.

An embodiment of this application further provides a computer program product. The computer program product includes a program. The computer program product may be applied to the terminal or the network device provided in embodiments of this application, and the program causes a computer to perform the methods performed by the terminal or the network device in various embodiments of this application.

An embodiment of this application further provides a computer program. The computer program may be applied to the terminal or the network device provided in embodiments of this application, and the computer program causes a computer to perform the methods performed by the terminal or the network device in various embodiments of this application.

It should be understood that the terms “system” and “network” in this application may be used interchangeably. In addition, the terms used in this application are only used to explain the specific embodiments of this application, and are not intended to limit this application. The terms “first”, “second”, “third”, “fourth”, and the like in the specification, claims, and drawings of this application are used to distinguish between different objects, rather than to describe a specific order. In addition, the terms “include” and “have” and any variations thereof are intended to cover a non-exclusive inclusion.

In embodiments of this application, “indicate” mentioned herein may refer to a direct indication, or may refer to an indirect indication, or may mean that there is an association relationship. For example, A indicates B, which may mean that A directly indicates B, for example, B may be obtained by means of A; or may mean that A indirectly indicates B, for example, A indicates C, and B may be obtained by means of C; or may mean that there is an association relationship between A and B.

In embodiments of this application, “B corresponding to A” means that B is associated with A, and B may be determined based on A. However, it should be further understood that, determining B based on A does not mean determining B based only on A, but instead, B may be determined based on A and/or other information.

In embodiments of this application, the term “correspond” may mean that there is a direct or indirect correspondence between the two, or may mean that there is an association relationship between the two, or may mean that there is a relationship such as indicating and being indicated, or configuring and being configured.

In embodiments of this application, “predefined” or “pre-configured” may be implemented by pre-storing corresponding code, tables, or other forms that may be used to indicate related information in devices (for example, including a terminal device and a network device), and a specific implementation thereof is not limited in this application. For example, being pre-defined may refer to being defined in a protocol.

In embodiments of this application, the “protocol” may refer to a standard protocol in the communications field, and may include, for example, an LTE protocol, an NR protocol, and a related protocol applied to a future communication system, which is not limited in this application.

In embodiments of this application, the term “and/or” is merely an association relationship that describes associated objects, and represents that there may be three relationships. For example, A and/or B may represent three cases: only A exists, both A and B exist, and only B exists. In addition, the character “/” in the specification generally indicates an “or” relationship between the associated objects.

In embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatus or units may be implemented in electronic, mechanical, or other forms.

The units described as separate components may be or may not be physically separated, and the components displayed as units may be or may not be physical units, that is, may be located in one place or distributed on a plurality of network units. Some or all of the units may be selected according to actual requirements to achieve the objectives of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state drive (SSD)), or the like.

The foregoing describes merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. An access network device, comprising a memory and a processor, wherein the memory is configured to store a program, and the processor is configured to invoke the program in the memory to cause the access network device to perform:
receiving timestamp information of first data, wherein the timestamp information is used to indicate a time at which a receiver or sender of the first data is expected to process the first data or/and a time at which the first data is transmitted.

2. The access network device according to claim 1, wherein the timestamp information is used to determine a processing policy for processing the first data by the access network device.

3. The access network device according to claim 1, wherein the processor is configured to invoke the program in the memory to cause the access network device to further perform:
receiving quality of service (QOS) information of the first data and/or associated information of the first data, wherein the associated information is used to indicate information of second data associated with the first data;
wherein the QoS information and/or the associated information and the timestamp information are used together to determine a processing policy for processing the first data by the access network device.

4. The access network device according to claim 2, wherein the processing policy for the first data comprises one or more of the following operations:
buffering of the first data;
a transmission time of the first data; and
resource allocation and/or scheduling of the first data.

5. The access network device according to claim 1, wherein
the receiver comprises one or more of the access network device, a core network element, an application server, and a terminal device; and
the sender comprises the access network device, a core network element, an application server, or a terminal device.

6. The access network device according to claim 5, wherein the terminal device comprises one or more of an access stratum (AS), a non-access stratum (NAS), and an application layer.

7. The access network device according to claim 1, wherein the timestamp information comprises one or more of the following information: a time at which the first data is expected to arrive at the receiver, a time at which the first data is expected to be decoded, a time at which the first data is expected to be played, a time at which the receiver is expected to send the first data, a time at which the sender is expected to send the first data, and the time at which the first data is transmitted.

8. The access network device according to claim 7, wherein the time at which the first data is expected to arrive at the receiver comprises one or more of the following:
a time at which the first data is expected to arrive at an access stratum (AS) layer of the receiver;
a time at which the first data is expected to arrive at a non-access stratum (NAS) layer of the receiver; and
a time at which the first data is expected to arrive at an application layer of the receiver.

9. The access network device according to claim 1, wherein
the timestamp information is carried on a user plane, or the timestamp information is comprised in a user plane message.

10. The access network device according to claim 9, wherein
the timestamp information is carried in a data packet of the first data.

11. The access network device according to claim 10, wherein
the timestamp information is comprised in a header of the data packet.

12. The access network device according to claim 9, wherein
the timestamp information is carried in one or more of the following messages: a medium access control control element (MAC CE), uplink control information (UCI), physical layer indication information, scrambling code information, port information, a transmission resource, and a resource request.

13. The access network device according to claim 12, wherein
the transmission resource or the resource request comprises one or more of the following messages: a buffer status report (BSR), a scheduling request (SR), an uplink shared channel (UL-SCH), a downlink shared channel (DL-SCH), an uplink (UL) scheduling grant, and downlink (DL) assignment.

14. The access network device according to claim 1, wherein
the timestamp information is carried on a control plane, or the timestamp information is comprised in a control plane message.

15. The access network device according to claim 14, wherein
the timestamp information is carried in terminal assistance information and/or a radio resource control RRC message.

16. The access network device according to claim 14, wherein
the timestamp information is comprised in a quality of service (QOS) parameter and/or time sensitive communication assistance information (TSCAI).

17. A core network element, comprising a memory and a processor, wherein the memory is configured to store a program, and the processor is configured to invoke the program in the memory to cause the core network element to perform:
sending timestamp information of first data, wherein the timestamp information is used to indicate a time at which a receiver or sender of the first data is expected to process the first data or/and a time at which the first data is transmitted.

18. The core network element according to claim 17, wherein the core network element is an SMF network element.

19. A terminal device, comprising a memory and a processor, wherein the memory is configured to store a program, and the processor is configured to invoke the program in the memory to cause the terminal device to perform:
sending timestamp information of first data, wherein the timestamp information is used to indicate a time at which a receiver or sender of the first data is expected to process the first data or/and a time at which the first data is transmitted.

20. The terminal device according to claim 19, wherein the processor is configured to invoke the program in the memory to cause the terminal device to further perform:
obtaining the timestamp information based on application layer information of the first data.
